(19) United States
(12) Patent Application Publication
(10) Pub. No.: US 2017/0308523 A1
(43) Pub. Date: Oct. 26, 2017

(54) A METHOD AND SYSTEM FOR SENTIMENT CLASSIFICATION AND EMOTION CLASSIFICATION

(71) Applicant: Agency for Science, Technology and Research, Singapore (SG)

(72) Inventors: Zhaoxia Wang, Singapore (SG); Siow Mong Rick Goh, Singapore (SG); Yinping Yang, Singapore (SG)

(21) Appl. No.: 15/523,201

(22) PCT Filed: Nov. 24, 2015
(86) PCT No.: PCT/SG2015/050469

§ 371 Date: Apr. 28, 2017

(30) Foreign Application Priority Data
Nov. 24, 2014 (SG) 10201407766R

(51) Int. Cl. G06F 17/27

(52) U.S. Cl. CPC G06F 17/279; G06F 17/2775; G06F 17/274; G06F 17/2705; G06F 17/273; G06F 17/2735

(57) ABSTRACT

A system and a method for classifying text messages, such as social media messages into sentiment valence categories are provided. The system comprising a module for decomposing text messages, a module for cleaning text messages, a module for producing feature data of text messages, and a module for classifying text messages into sentiment valence categories. The module for decomposing text messages is configured to: receive a text message, parse the text message into separate portions in response to parsing criteria based on sentence delimiters, wherein the separate portions are sentences, phrases and words, and rejoin at least some of the separate portions of the text message into sentences in response to predefined linguistic conditions.

### PRIORITY CLAIM

The present application claims priority to Singapore Patent Application No. 7201407766R, filed 24 Nov. 2014.

### FIELD OF THE INVENTION

The present invention generally relates to text data analytics, such as social media analytics, and more particularly relates to a method and system for sentiment classification of text (e.g., social media text).

### BACKGROUND

Social media has a vast amount of publicly available user-generated content, which offers merchants and organizations a larger, richer, closer-to-real-time data source of consumer insights than conventional means. Many customer-facing merchants and organizations are exploring the real business values of social media by seeking answers to important questions asked by marketing, product innovation, research and development (R&D), customer relations, public relations (PR) and branding practitioners. For example, sales and marketing managers need to make forecasts on the sales of new products. Product innovation and R&D directors need to understand consumer attitudes and preferences towards their products and services. Customer relationship managers and PR professionals need to detect any potential critical product/brand or service crisis early to devise risk-management strategies or capitalize on positive sentiments towards their brands.

Social media can be valuable in a number of application domains, but the adoption of only one sentiment classification method without an assurance of a sufficient level of accuracy may limit or bias prediction results. Therefore, despite the significant potential in harnessing consumer insights from social media, technical challenges still exist in finding an accurate yet cost-effective sentiment classification that is applicable to real-world multi-domain contexts.

To understand customer opinions, a fundamental task is to identify the orientation of opinions in a given piece of text message (e.g., tweets, blogs, review websites, news or forums) and whether a customer expresses a positive, negative, or neutral attitude towards a product/brand or service. Insufficiently accurate sentiment classifications will give unreliable recommendations for actions or limit the predictive capability of social media text analysis.

There are generally two approaches to sentiment classification: a learning-based approach and a non-learning based approach (e.g. a lexicon-based approach). Each approach has its own limitations. The learning-based approach typically requires large, high-quality training databases to be effective, while the lexicon-based approach typically lacks the capability to handle semantic ambiguity. As humans express their attitudes and emotions very differently in different linguistic groups, social contexts, topic domains, and individual situations, the existing sentiment classification methods face the common challenge of being applicable to new domains without significant time being invested in manual correct-labeling of large databases. Such challenges may result in delays in configuration and may even fail to perform if new data/patterns emerge that fall out of the training domain.

Thus, what is needed is an efficient and accurate method and system for sentiment classification of text, such as social media data, utilizing advanced linguistic processing and social adaptive fuzzy rule inference techniques. Furthermore, other desirable features and characteristics will become apparent from the subsequent detailed description and the appended claims, taken in conjunction with the accompanying drawings and this background of the disclosure.

### SUMMARY

In accordance with a first aspect of the present invention, a method for decomposing text messages is disclosed, the method comprising: receiving a text message; parsing the text message into separate portions in response to parsing criteria based on sentence delimiters, wherein the separate portions can be sentences, phrases and words; rejoining at least some of the separate portions of the text message into sentences in response to predefined linguistic conditions; and outputting the separate portions of the text message.

In accordance with a second aspect of the present invention, a method for cleaning text messages for processing in accordance with a predefined purpose is disclosed, the method comprising: receiving separate portions of a text message; comparing character sequences of each separate portion in the message with a predefined database; removing a character sequence in response to the character sequence not matching a term in the predefined database; replacing the separate portion with a term having an equivalent meaning in the predefined database in response to the separate portion matching a predefined reserved term and a predefined sentence structure in the predefined database; respelling a word in the separate portion to a nearest spelling of a word available in the predefined database in response to the word in the separate portion not matching a term in the predefined database but differing from matching a term in the predefined database by letter repetitions within the word, wherein a term is added to the separate portion to express a similar degree of emphasis as the letter repetitions; comparing each processed separate portion with data stored in a predefined purpose-based lexicon to determine whether the separate portion is relevant to the predefined purpose for further processing.

In accordance with a third aspect of the present invention, a method for producing feature data of a text message is disclosed, the method comprising: defining a knowledge based module comprising a plurality of predefined databases including one or more of an emotion dictionary database, a social media lexicon database, a local language lexicon database, a domain lexicon database, and a fuzzy table database; defining an adaption module in response to user construction of a domain-specific lexicon; defining middle classes based on the database within the knowledge based module; receiving a text message and extracting features of the text message, wherein a feature is a finite set of words, phrases or abbreviations expressing predefined purposes; determining sentence component features of the text message based on grammatical structure between features of each sentence of the text message; comparing one of the sentence component features with predefined sentence component structures and meanings based on the knowledge base module, and applying predetermined sentence rules to the sentence component feature in response to the sentence component feature matching the predetermined sentence component structures and meanings; calculating a feature value for each feature of the text message in respect to a membership degree of the feature with respect to every predefined middle class; forming a feature matrix based on the calculated feature values; calculating sentence component feature values in response to the feature matrix; and forming a sentence component feature vector in response to the sentence component feature values and sentence component features.

In accordance with a fourth aspect of the present invention, a system for classifying text messages into sentiment valence categories is disclosed, the system comprising: a module for decomposing text messages; a module for cleaning text messages; a module for producing feature data of text messages; and a module for classifying text messages into sentiment valence categories, wherein the module for decomposing text messages is configured to: receive a text message; parse the text message into separate portions in response to parsing criteria based on sentence delimiters, wherein the separate portions are sentences, phrases and words; and rejoin at least some of the separate portions of the text message into sentences in response to predefined linguistic conditions.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1, comprising FIGS. 1A and 1B, depicts block diagrams of a system for sentiment classification in accordance with a present embodiment, wherein FIG. 1A depicts an overview of the system and FIG. 1B depicts an operational block diagram of the system.

FIG. 2 depicts a flowchart of an overview of the operation of the classification modules of the system depicted in FIG. 1 in accordance with the present embodiment.

FIG. 3, comprising FIGS. 3A to 3D, depicts more detailed flowcharts of the operations of the main modules of FIG. 1B in accordance with the present embodiment, wherein FIG. 3A depicts a flowchart of the operation of the decomposing module, FIG. 3B depicts a flowchart of the operation of the cleaning module, FIG. 3C depicts a flowchart of the operation of the feature selection module, and FIG. 3D depicts a flowchart of the operation of the fuzzy rule inference module.

FIG. 4 depicts a block diagram of a data processing and analysis system incorporating the classification modules in accordance with the present embodiment.

FIG. 5 depicts a flowchart of the operation of the system of FIG. 4 in accordance with the present embodiment.

FIG. 6 depicts an operation workflow of a noise filter of the system of FIG. 4 in accordance with the present embodiment

And FIG. 7 depicts a schematic diagram of a computing device suitable for executing the methods and systems in accordance with the present embodiment.

Skilled artisans will appreciate that elements in the figures are illustrated for simplicity and clarity and have not necessarily been depicted to scale. For example, the dimensions of some of the elements in the block diagrams or flowcharts may be exaggerated in respect to other elements to help to improve understanding of the present embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the present embodiment to present an efficient and accurate method and system for sentiment classification of text, such as social media data, utilizing advanced linguistic processing and social adaptive fuzzy rule inference techniques.

The term “social media” generally refers to Internet-based applications, tools and websites that allow the creation, exchange and access of user-generated content.

The term “social media data” generally refers to social media data in textual form, including, but not limited to, texts, text messages, short message service (SMS) messages, instant messaging text messages, or any texts or text messages that can be accessed in the social media.

The term “message” generally refers to a piece of information containing at least a phrase or a sentence in textual form.

The term “SentiMo” refers to processing engine with several component modules for sentiment classification of text in accordance with a present embodiment.

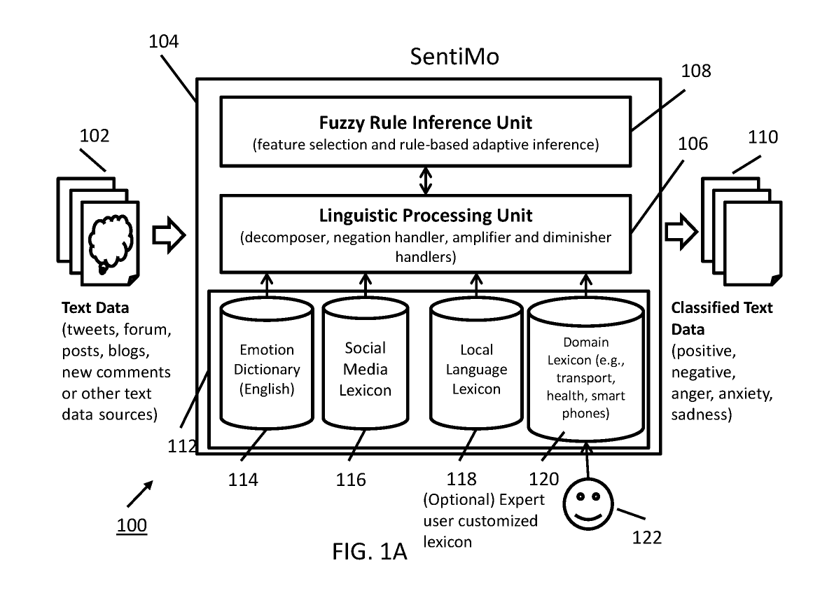

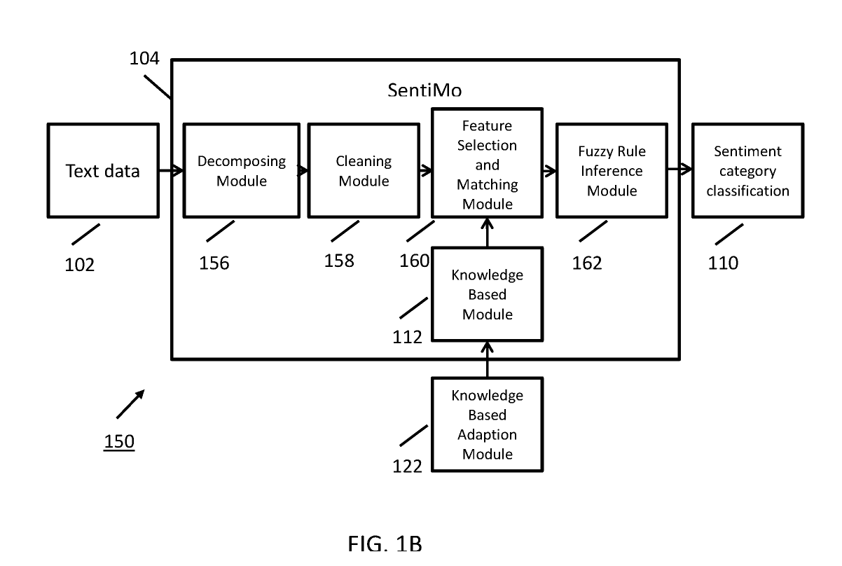

FIG. 1A depicts a block diagram 100 of an overview of a system for sentiment classification and its main components in accordance with the present embodiment. The system broadly includes the SentiMo processing engine 104 and a knowledge based module 112. Text data 102, collected from Internet social media or other text data sources, is received by the SentiMo 104, which includes a linguistic processing unit 106 and a fuzzy rule inference unit 108. The linguistic processing unit 106 pre-processes the text data and then sends the processed data to the fuzzy rule inference unit 108 for sentiment classification. Once the sentiment classification is completed, the classified text data 110 is outputted from the SentiMo 104.

The knowledge based module 112 provides dictionary and lexicon databases for use by the SentiMo 104 including an emotion dictionary 114, a social media lexicon 116, a local language lexicon 118 and a domain lexicon 120. In addition, the knowledge based module 112 may optionally be coupled to an expert user customized lexicon 122 acting as a knowledge based adaption module, such that it allows users to develop the domain lexicon 120 into a domain-specific “seed” lexicon database to enhance domain adaptability.

In accordance with the present embodiment, the language of the text data that the SentiMo 104 processes and the language of the knowledge based module 112 are in English. However, the language may include other non-English languages, such as, but not limited to, Chinese (both traditional and simplified), Malay, Indian, French, German, Japanese and Korean.

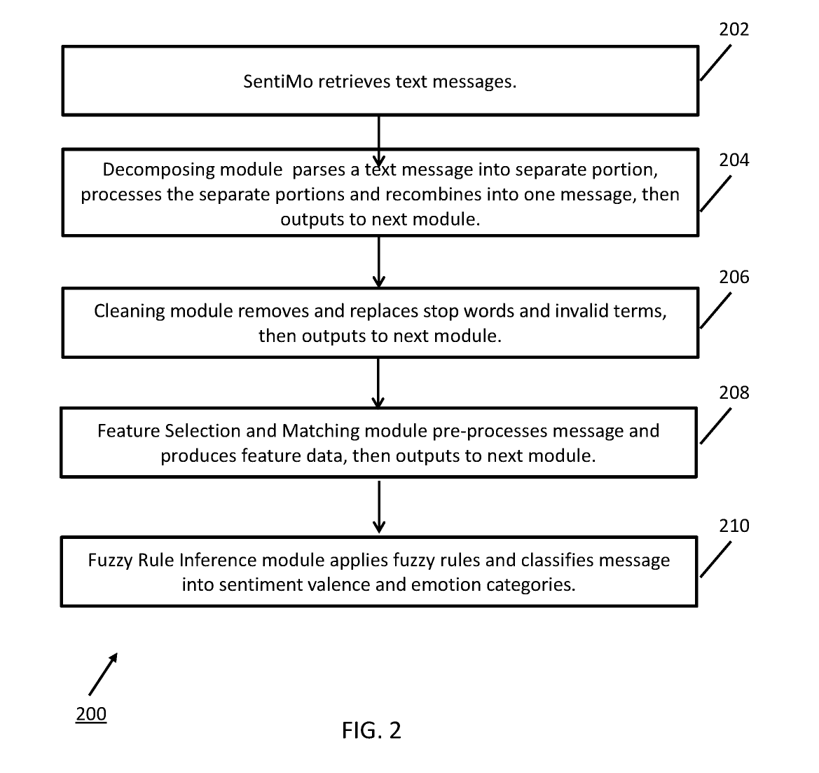

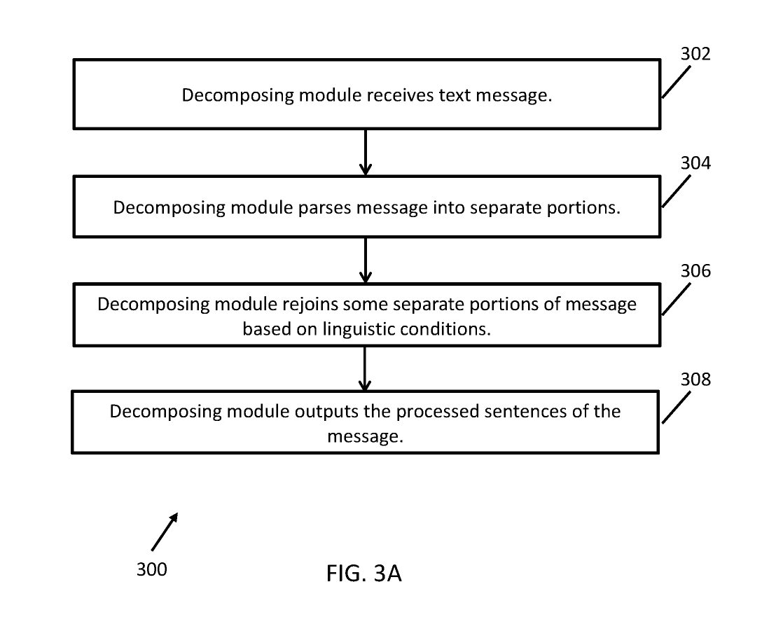

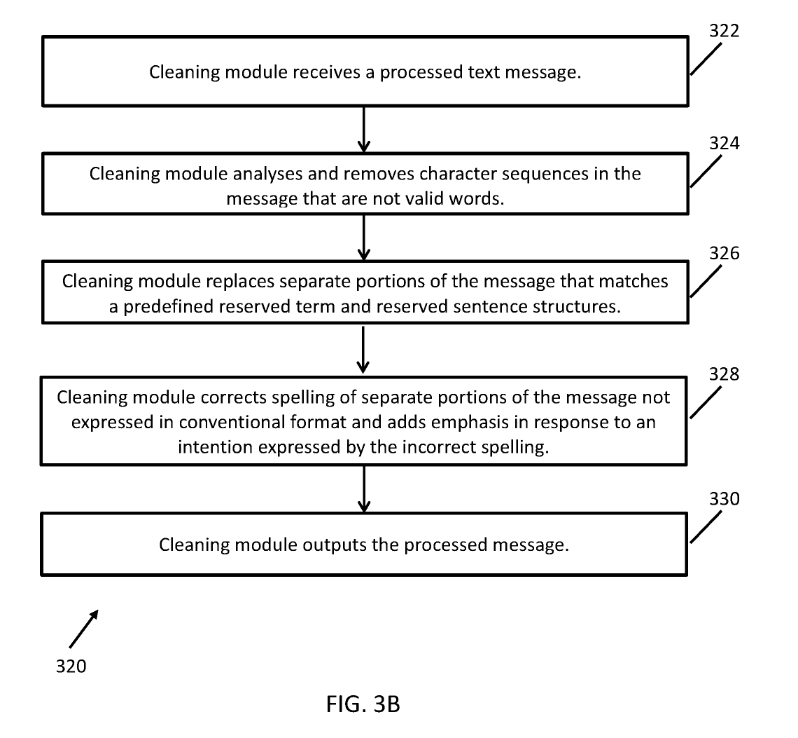

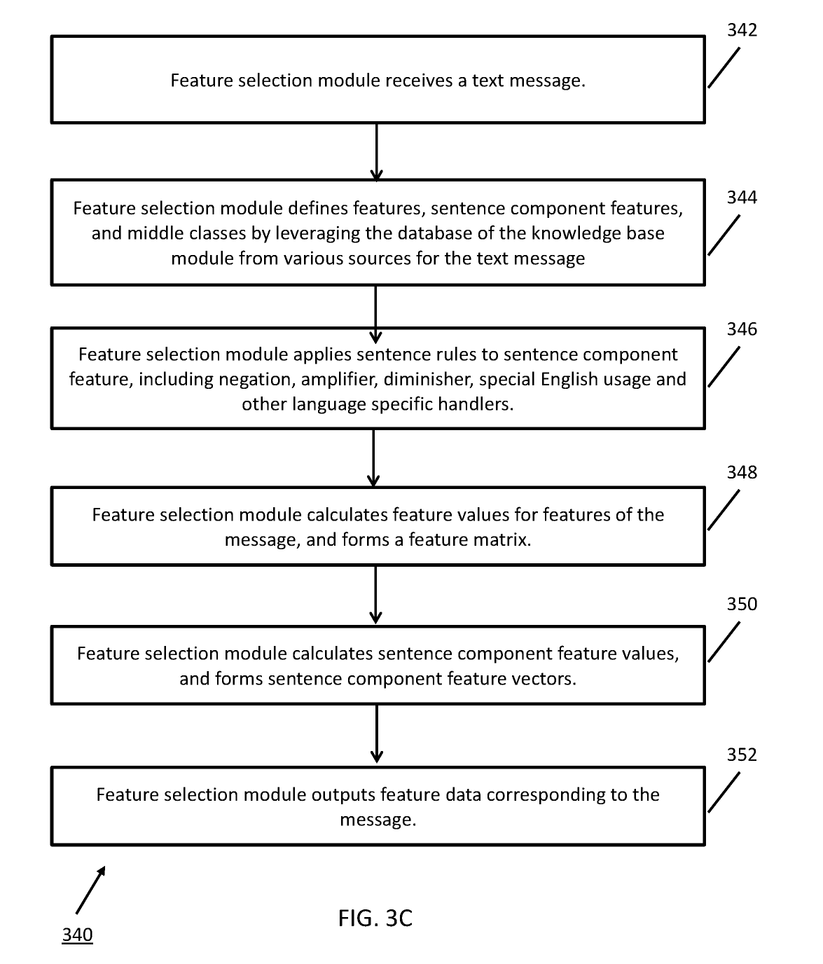

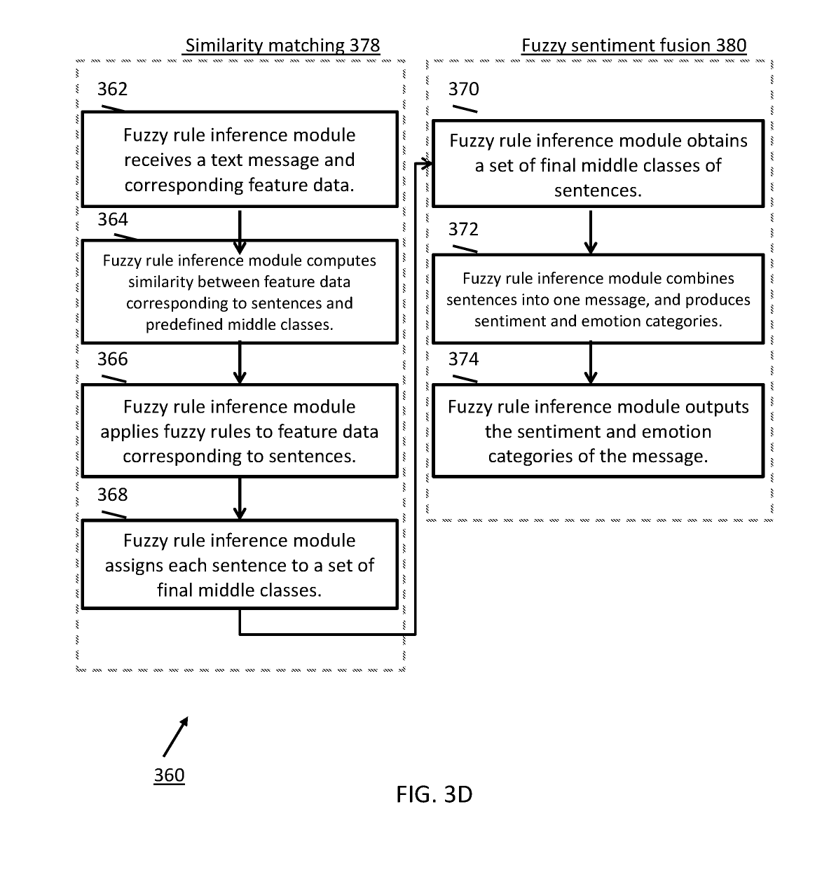

FIG. 1B depicts an operational block diagram 150 of the SentiMo sentiment classification system from a modular perspective. The text data 102, collected from Internet social media or other text data sources, is received by the SentiMo 104 consisting of four modules: a decomposing module 156, a cleaning module 158, a feature selection and matching module 160 and a fuzzy rule inference module 162. The knowledge based module 112, consisting of various dictionary, lexicons and purpose-based databases, is connected to the feature selection and matching module 160. Further, the knowledge based adaption module 122, which is a domain-specific “seed” lexicon database constructed by experts and practitioners in the domain, is coupled to the knowledge based module 112. Once the sentiment classification in the SentiMo 104 is completed, the classified sentiment category 110 of the text data is outputted. General operation of each module in the SentiMo 104 in accordance with the present embodiment is described in the flowcharts of FIG. 2 and FIG. 3.

FIG. 2 depicts a flowchart 200 of a general overview of operation of the main modules in the SentiMo 104. The SentiMo 104 retrieves 202 text messages 102 from the Internet and passes the text messages to the decomposing module 156. The decomposing module 156 parses 204 each message into separate portions based on sentence delimiters, and rejoins at least some of the portions based on specific linguistic conditions. It then outputs the processed message to a cleaning module 158. The cleaning module 158 removes 206 stop words and invalid terms, and replaces the invalid terms with valid terms from a predefined database. The cleaned message is then output to the feature selection and matching module 160. The feature selection and matching module 160 pre-processes 208 the message based on some predetermined sentence rules, and produces 208 feature data corresponding to the message. It then outputs the message together with the feature data to a fuzzy rule inference module 162. The fuzzy rule inference module 162 applies 210 fuzzy rules to the feature data of the message and classifies 210 the message into sentiment valence and emotion categories.

Referring to FIG. 3A, a flowchart 300 depicts an operation of the decomposing module 156 in the SentiMo 104 in accordance with the present embodiment. Advantageously, the decomposing module 156 adaptively parses a text message into separate portions such as a sentence, a phrase or words. It also adaptively analyzes differently the separate portions and rejoins at least some of them into one portion when certain specific linguistic conditions are met.

In operation, the decomposing module 156 receives 302 a text message, and parses 304 the message into separate portions in response to parsing criteria based on detecting and identifying punctuation marks in the message that are considered to be sentence delimiters. Sentence delimiters may also be control characters such as a carriage return and a newline. The portions of the message may be a sentence, a phrase or words.

While the parsing criteria of identifying punctuations marks as sentence delimiters works in general, there are some exceptions. For example, the period in “Mr. Lee” is not considered a sentence delimiter though the period is a common punctuation mark. The decomposing module 156 analyzes the context and determines that it will not parse this term into portions. The decomposing module 156 maintains a database of exception expressions such that when a sentence of a message matches one of the listed exceptions, the decomposing module 156 will not perform parsing 304.

Next, the decomposing module 156 analyzes the separate portions and if certain specific linguistic conditions are met, then the portions are rejoined 306. For example, the two sentences, “You guess, comparing A and B, which one would I prefer?” and “I prefer B.” rejoins and becomes “You guess, comparing A and B, which one would I prefer? I prefer B.” The linguistic condition is such that the two sentences are so linked to each other, it is preferable to combine them together as one portion. The decomposing module 156 has a set of predefined linguistic conditions to identify whether the sentences within a message meet one of those conditions for rejoining sentences 306. The decomposing module 156 further outputs 308 processed sentences of the message, which are the basic units for sentiment analysis for subsequent steps.

FIG. 3B depicts a flowchart 320 of an operation of the cleaning module 158 in the SentiMo 104. The cleaning module 158 advantageously removes and cleans certain characters and predetermined portions in a text message that are considered invalid terms, or expressed in unconventional formats. By removing invalid character sequences and predetermined portions in the message, it advantageously reduces the overall processing time. The cleaning module 158 also advantageously replaces predetermined portions in the message that match reserved terms in a predefined database, so as to avoid confusion or ambiguity with reserved sentiment and emotion terms.

The cleaning module 158 receives 322 all portions of a text message from the decomposing module 156 and analyzes 324 character sequences in the message to determine whether the character sequences are valid terms. The valid terms are defined by a predefined database, which may be constructed from a standard English dictionary and user-defined lexicons. If the character sequences are determined to not be valid terms, the cleaning module 158 removes 324 the invalid character sequences from the message. For example, a character sequence may be an Internet web address specified by a uniform resource locator (URL), which is usually expressed in the form of “http:// . . . ”. In which case, the cleaning module 158 detects the character sequence starting with the special term “http”, and removes 324 the characters within that character sequence starting with “http”, followed by successive characters, and ending, perhaps, with a predefined delimiter such as a carriage return or a newline control character. In other words, the cleaning module 158 removes 324 the character sequence starting from “http” and up to the predefined delimiter.

Next, the cleaning module 158 analyzes the separate portions of the message according to sentence structure, and determines if any of the portions match a reserved term as well as a reserved sentence structure in the predefined database. If the predetermined portion matches both conditions, the cleaning module 158 replaces 326 the predetermined portion with a term having an equivalent meaning in the predefined database. For example, the phrase “as well as” may be easily confused with the positive sentiment term “well”. In order to avoid this confusion, the cleaning module 158 replaces 326 the phrase “as well as” with a term having an equivalent meaning (e.g., the term “and”). Thus, the cleaning module 158 advantageously replaces some terms with an equivalent to avoid confusion and ambiguity with sentiment and emotion terms.

Furthermore, the cleaning module 158 analyzes separate portions of the message and determines whether there are some portions or spellings which match a term in the predefined database, and whether they are expressed in a predefined format. The predefined format is a set of specific language rules for terms expressed in an unconventional or non-standard way. If spelling criterion is not met but the predetermined portion is expressed in the predefined format, then the cleaning module 158 corrects 328 the spelling of the predetermined portion to the nearest spelling of a term available in the predefined database. Additionally, the cleaning module 158 may add 328 an emphasis term to the predetermined portion, where the emphasis term has a similar degree of emphasis to the predefined format (e.g., where the predefined format includes additional letter repetitions). For example, in accordance with the present embodiment, the expressions “gooooood”, “greeeeeat” and “soooooo expensive” may be replaced with the terms “very good”, “so great” and “very very expensive”, respectively. The steps of operations for this example are described as follows. First the cleaning module 158 determines whether these expressions match any term in the predefined database. It is clear that the three expressions do not match as the spellings are not correct. However, they match the predefined format as they are proper terms spelt in an unconventional way, i.e., repeated letters. As such, the cleaning module 158 first corrects 328 the spelling to “good”, “great” and “expensive”, respectively. Then, the cleaning module 158 adds 328 an emphasis term to the expressions that has a similar degree of emphasis as the letter repetitions provide to the predefined format. Thus, the expressions become “very good”, “so great” and “very very expensive”, respectively. This special noise cleaning capability advantageously transforms terms that are popular but expressed in unconventional formats into standard spelling with a similar degree of emphasis (such as an amplifier indicator, “very”) which will be further processed by one or more handlers in the feature selection and matching module 160.

FIG. 3C depicts a flowchart 340 of an operation of the feature selection and matching module 160 in the SentiMo 104. The feature selection and matching module 160 advantageously produces feature data through matched lexicons and phrases according to predefined databases, and extracts sentence component features from each sentence, such that the sentiment and emotion may be conveniently obtained through calculating the corresponding feature data of the message.

Thus in accordance with the present embodiment, the feature selection and matching module 160 receives 342 separated portions of a text message from the cleaning module 158; defines 344 features of each sentence in the message where a feature is a finite set of words, phrases or abbreviations selected for predefined purposes; defines 344 middle classes (which serve as predefined middle classes) by leveraging the database information of knowledge base module 112; and defines 344 sentence component features based on grammatical structure between words of each sentence of the message. The knowledge based module 112 is defined 344 and connected to the feature selection and matching module 160 to provide all necessary information and references to the module. The feature selection and matching module 160 also defines 344 middle classes based on the database within the knowledge based module 112.

Next, the feature selection and matching module 160 compares a sentence component feature corresponding to a sentence of the message with predefined sentence component structures and meanings from the knowledge based module 112. If the sentence component feature matched with the predetermined sentence component structures and meanings, then the feature selection and matching module 160 applies 346 predetermined sentence rules to the sentence component feature. In accordance with the present embodiment, there are several predetermined sentence rule handlers: a negation handler, an amplifier, a diminisher handler, and a special language usage handler, and they are described as follows.

The negation handler negates the polarity of sentiment of a sentence component feature of a text message. It compares the sentence component feature with a predetermined polarity of sentiment conditions. If the conditions are matched, then the polarity of the sentiment of the sentence component feature is negated. For example, the expression “I like” is a positive sentiment, but the expression “I do not like” is not. Thus, the negation handler analyzes the expression with predetermined sentence rules and predetermined polarity of sentiment conditions, and negates this expression as non-positive.

The amplifier handler increases the degree of emphasis of a sentence component feature of a text message when certain predetermined sentence rules are met. Specifically, the amplifier handler detects whether an amplifier indicator is present in the sentence component feature. The amplifier indicator can either be already present in the sentence component feature, or it can be an emphasis term of a predetermined portion that has been processed by the special noise cleaner in the cleaning module 158. Examples of amplifier indicator include “very”, “too” and “so much”. If the amplifier indicator is present, the amplifier handler analyzes the amplifier indicator and increases the degree of emphasis of the sentence component feature in which the amplifier indicator acts on.

Similarly, the diminisher handler decreases the degree of emphasis of a sentence component feature of a text message when certain predetermined sentence rules are met. Specifically, the diminisher handler detects whether a diminisher indicator is present in the sentence component feature. The diminisher indicator can either be already present in the sentence component feature, or it can be an emphasis term of a predetermined portion that has been processed by the special noise cleaner in the cleaning module 158. Examples of diminisher indicator include “slight”, “somewhat” and “a little”. If the diminisher indicator is present, the diminisher handler analyzes the diminisher indicator and decreases the degree of emphasis of the sentence component feature in which the diminisher indicator acts on.

The special language usage handler handles a sentence component feature that cannot be expressed or understood in standard knowledge based format (e.g., “f-cking” and “sh!t”, which do not belong to a standard dictionary). Thus, the special language usage handler solves this issue by applying predetermined sentence rules with special language specific rules to the sentence component feature. For example, the actual meaning of the term “f-cking” in a sentence may not be clear, i.e., it can be positive or negative depending on context within the sentence. Thus, the special language usage handler analyzes the term in context and applies predetermined sentence and specific rules to understand the logic and actual meaning of the term. In effect, the language usage handler compares the sentence component feature with a predefined reserved term in the knowledge base module 112. It then applies language specific rules to analyze the context and logic of the sentence component feature. After that, it determines the actual meaning of the sentence component feature, and assigns a polarity of the sentiment of the sentence component feature for later processing.

Returning to the feature selection and matching module 160, after applying 346 predetermined sentence rules to the sentence component feature, the feature selection and matching module 160 calculates 348 a feature value for each feature of the text message in respect to a membership degree of the feature with respect to every predefined middle class. Based on the calculated feature values for the message, a feature matrix is formed. Further, the sentence component features values may be calculated 350 from the feature matrix, and a sentence component feature vector may be formed 350 in response to the sentence component feature values together with the sentence component features. Finally, the feature selection and matching module 160 outputs 352 the feature data corresponding to the text message comprising the feature matrix, at least one feature vector, and at least one sentence component feature vector for further processing.

In conjunction with the feature selection and matching module 160, there is provided a knowledge based module 112 consisting of various dictionaries, lexicons and purpose-based databases, including an emotion dictionary database 114, a social media lexicon database 116, a local language database 118 and a domain lexicon database 120 as well as an emotion lexicon fuzzy table database and other user defined, purpose-based databases. The knowledge based module 112 is connected to the feature selection and matching module 160, which readily provides all the necessary information and references to fulfill the required tasks. For example, a sentiment and emotion category definition database in accordance with the present embodiment is shown in Table 1-1. The list is not exhaustive and may be added to or modified. The predefined middle classes may be drawn from this category definition database listed in Table 1-1 and predefines some new categories such as additional categories not listed in Table 1-1 as well as categories derived from combining the existing categories in Table 1-1 (e.g., Positive Gratitude).

TABLE 1-1
Sentiment and emotion category definition database.

| No | Sentiment and emotion categories |
|---|---|
| 1 | Positive |
| 2 | Gratitude |
| 3 | Respect |
| 4 | Excited |
| 5 | Happy |
| 6 | Joy |
| 7 | Trust |
| 8 | Negative |
| 9 | Anxiety |
| 10 | Anger |
| 11 | Sad |
| 12 | Disgust |
| . . . | . . . |

Similarly, the possible sentence-component-category definition database in accordance with the present embodiment is shown in Table 1-2. The list of categories is also not exhaustive and may be added to or modified.

TABLE 1-2
Example of Sentence-component-category definition database

| No | Sentence-component-categories |
|---|---|
| 1 | Pronoun |
| 2 | Ppron |
| 3 | I |
| 4 | We |
| 5 | You |
| 6 | SheHe |
| 7 | They |
| 8 | Ipron |
| 9 | Article |
| 10 | Verbs |
| 11 | AuxVb |
| 12 | Nouns |
| 15 | Adverbs |
| 16 | Prep |
| 17 | Conj |
| 18 | Subjects |
| 19 | Objects |
| 20 | Predicates |
| . . . | . . . |

The domain category definition database in accordance with the present embodiment is shown in Table 1-3. The list of categories is also not exhaustive and may be added to or modified.

TABLE 1-3
Example of domain category definition database

| No | Domain categories |
|---|---|
| 1 | Transportation |
| 2 | Healthcare |
| 3 | Hotel |
| 4 | Company-Evaluation |
| 5 | GOV-Evaluation |
| 6 | Internet |
| 7 | LoT |
| 8 | Home |
| 9 | Money |
| 10 | Relig |
| 11 | Death |
| 12 | Social |
| 13 | Family |
| 14 | Food |
| 15 | Tourism |
| 16 | Agriculture |
| 17 | Manufacturing |
| 18 | Financial |
| 19 | Insurance |
| 20 | Housing |
| . . . | . . . |

Another example is an emotion lexicon fuzzy table database shown in Table 2. The list is also not exhaustive and may be added to or modified. In Table 2, the fuzzy number has a range of 0 to 1, which indicates a measure of a word belonging to a middle class category. A word with a larger fuzzy number represents a stronger affinity to that middle class category. Likewise, a word with a smaller fuzzy number represents a weaker affinity to that middle class category.

TABLE 2
Emotion lexicon fuzzy database.

| Words | Belong to middle categories | Fuzzy numbers |
|---|---|---|
| Great | 1 | 0.9 |
| Strong | 1 | 0.8 |
| Nice | 1 | 0.8 |
| Pretty | 1 | 0.9 |
| Beautiful | 1 | 0.9 |
| Anxious | 8 | 0.8 |
| Lousy | 8 | 0.8 |
| Aweful | 8 | 0.8 |
| Angry | 8 | 0.9 |
| Sad | 8 | 0.7 |
| . . . | . . . | . . . |

In addition to the above, there is also provided a user configurable module called a knowledge based adaption module 122 that is coupled to the knowledge base module 112. It is a domain-specific “seed” lexicon database constructed by experts and practitioners in the domain. This module advantageously enhances the capture of important domain-specific sentiment and emotion nuances, thereby achieving higher measurement accuracy than simple lexicon-based or learning-based methods. In general, the initial domain-specific “seed” lexicon requires approximately six man-hours or more to develop.

FIG. 3D depicts a flowchart 360 of an operation of the fuzzy rule inference module 162 in the SentiMo 104. The fuzzy rule inference module 162 includes two portions: similarity matching 378 and fuzzy sentiment fusion 380. In the similarity matching 378 portion, the fuzzy rule inference module 162 receives 362 a text message and the corresponding feature data. The module computes 364 similarities between feature data corresponding to the sentences of the message and the predefined middle classes. Next, a set of designed fuzzy rules are applied 366 to the feature data corresponding to the sentences of the message. After that, each sentence of the message is assigned 368 to a set of final middle classes as defined in step 344 by leveraging the database of knowledge based module 112. The final middle classes of sentences of the message are passed to the next step for further processing.

In the fuzzy sentiment fusion 380 portion, after obtaining 370 the final middle classes for each sentence from the similarity matching portion 378, the sentences are combined 372 into one message, and the final sentiment valence and emotions categories of the entire message are produced 372. The classified message, together with its sentiment and emotion categories is outputted 374 for further analysis, in accordance with the present embodiment.

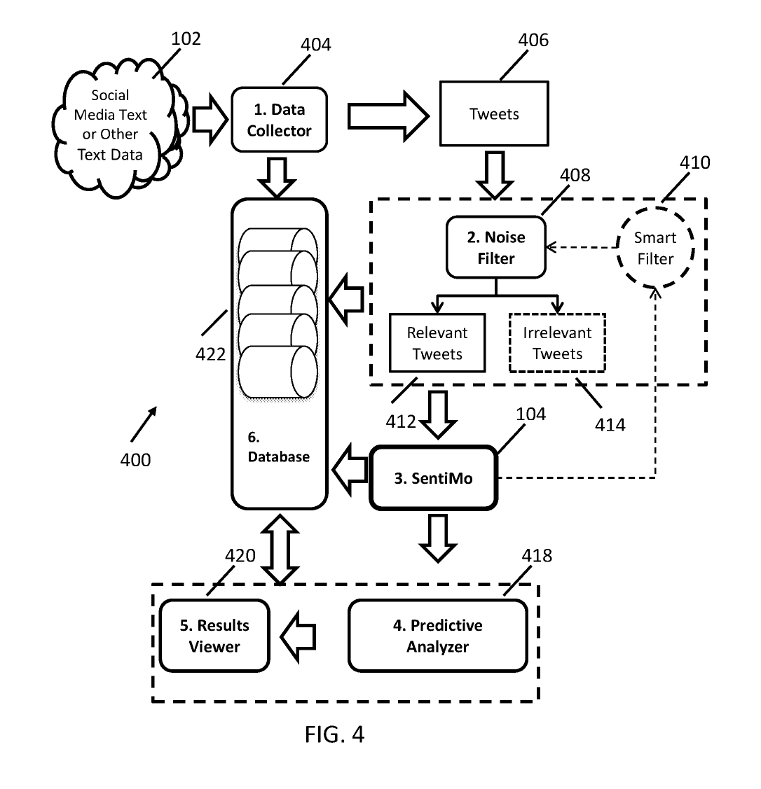

FIG. 4 depicts a block diagram 400 of a data processing and analysis system in accordance with the present embodiment. The end-to-end text analysis system of FIG. 4 advantageously demonstrates a real-world implementation of the SentiMo processing engine104. The system comprises six modules, including a social data collector module 404, a noise filter module 408 incorporating a smart filter 410, a sentiment and emotion classifier 104 (i.e., the SentiMo 104), a predictive analyzer module 418, a results viewer module 420 and a database module 422. The system of FIG. 4 advantageously provides useful information for marketing research personnel, product suppliers, service providers and system integrators.

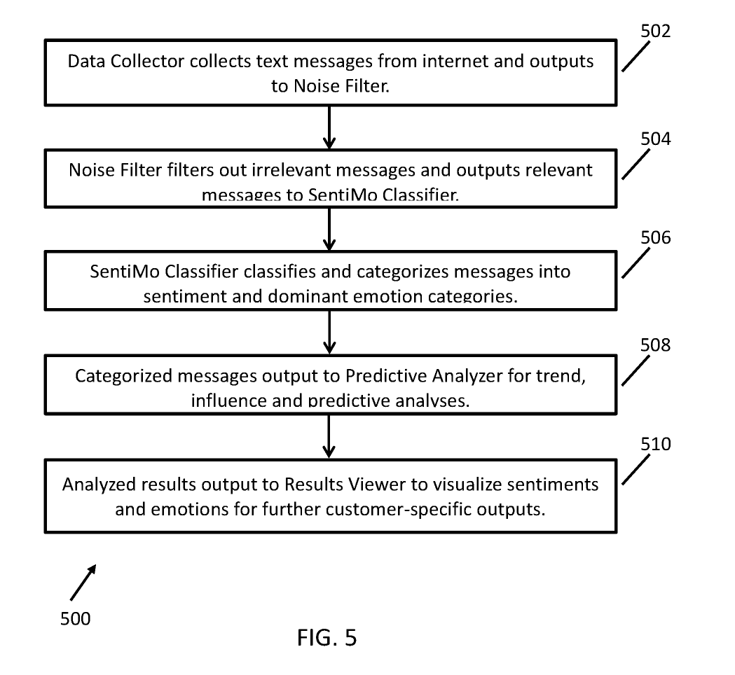

Before going into details of each module in the system 400, a general overview is described. FIG. 5 depicts a flowchart 500 of the operation of the system of FIG. 4. A data collector module 404 retrieves 502 text messages 406 from the text data 102 on the Internet or other data sources and outputs the text messages 406 to a noise filter module 408. The noise filter module 408 filters out 504 irrelevant messages 414 based on a set of predefined filtering rules and outputs relevant messages 412 to the SentiMo classifier module 104. The SentiMo classifier module 416 classifies and categorizes 506 messages into sentiment and dominant emotion categories. The categorized messages, together with associated sentiments and emotions, are outputted to a predictive analyzer module 418 for trend, influence and predictive analysis 508. The results are outputted 510 to, and displayed by, a results viewer module 420. The results viewer module 420 provides a graphical user interface to interactively and dynamically visualize results.

The data collector module 404 retrieves the text data 406 from various social media sources or other text data sources 102, including but not limited to sources from the Internet, such as Internet forums (e.g., HardwareZone and reddit), social networking websites (e.g., Twitter and Facebook), and weblogs (e.g., Blogger, Tumblr and WordPress). An exemplary text data 406 in accordance with the present embodiment are messages posted on Twitter, colloquially called “tweets”. The data collector module 404 interfaces and communicates with social media sources or other text data sources 102 to collect text data. The interface may be an application program interface (API) that is provided by social media sources or other text data sources 102 service providers. For example, Twitter's REST and streaming APIs and Facebook's Graph API. The collected text data 406 is sent to the noise filter module 408 for processing.

The noise filter module 408 removes noisy irrelevant messages 408 received from the data collector module 404. Examples of irrelevant messages 414 are advertisements, contents which do not include any comments on a product or a service, and other irrelevant content-specific noises. The filtered relevant messages 412 are then sent to the next module.

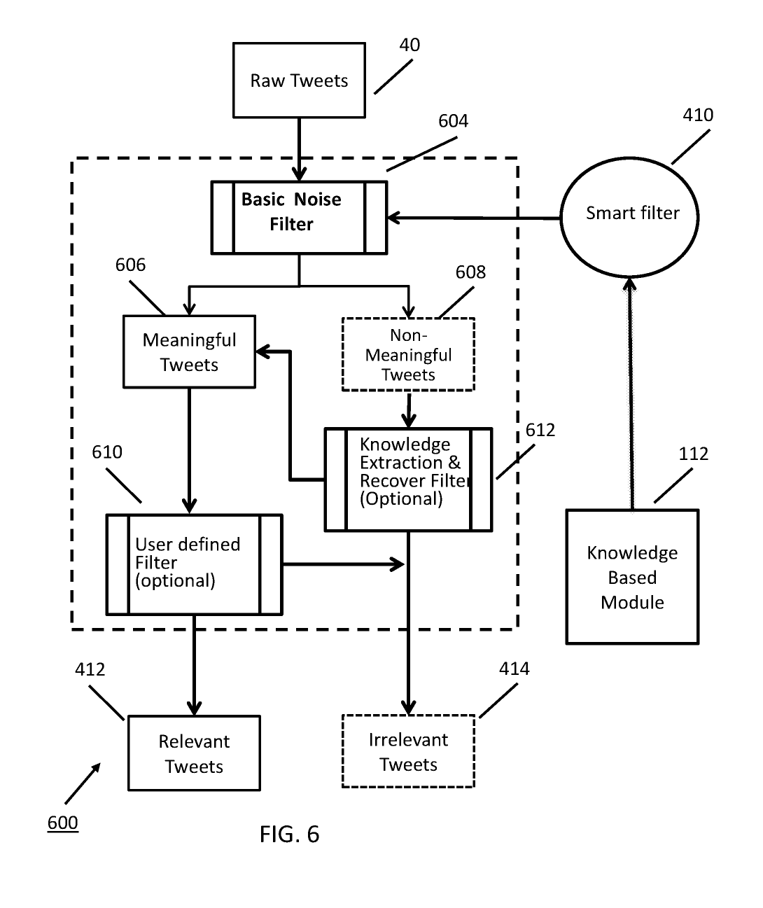

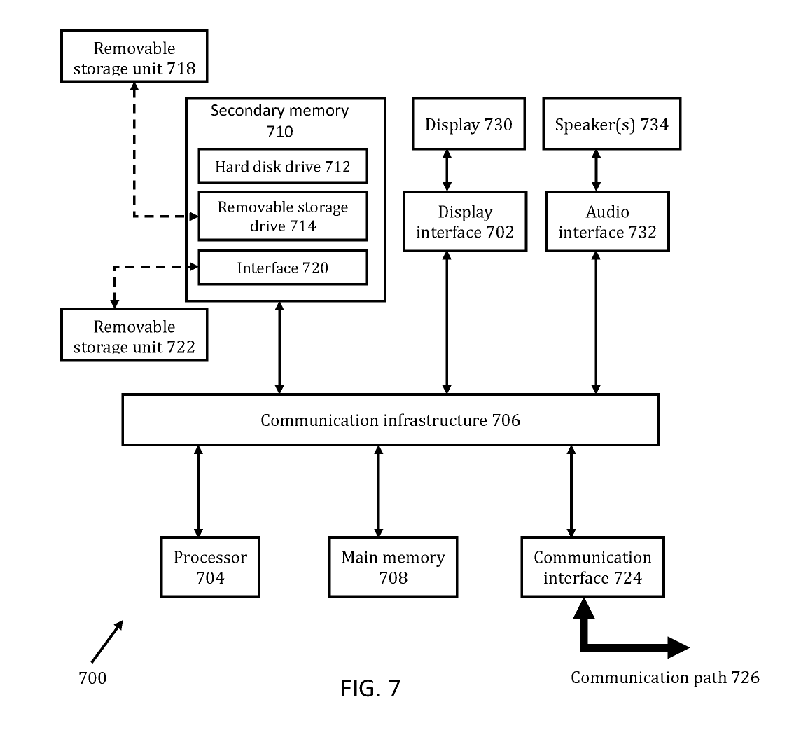

To give more details on the operation of the noise filter module 408, Twitter messages (i.e., tweets) are used as an illustration. Referring to FIG. 6, an operation workflow 600 of the noise filter module 408 is depicted. This module includes three sub-modules: a basic noise filter 604, a knowledge extraction & recover filter 612 and a user defined filter 610. Raw tweets 406 are first pre-processed by the basic noise filter 604 to determine if they are meaningful tweets 606 or non-meaningful tweets 608. The non-meaningful tweets 608 are passed to the knowledge extraction & recover filter 612 to determine if the non-meaningful tweets 608 are meaningful tweets 606 or irrelevant tweets 414. Essentially, the knowledge extraction & recover filter 612 further analyzes the non-meaningful tweets 608 and extracts the meaningful ones and recovers them into meaningful tweets 606. The meaningful tweets 606 are passed to a user defined filter 610. This is an optional filter that allows the user to define rules to differentiate between relevant tweets 412 and irrelevant tweets 414. These filtering steps ensure the text data passed to the SentiMo classifier module 104 are relevant to the intended purposes for analysis. Additionally, the noise filter module 408 includes an optional smart filter module 410, which provides predetermined sentence rules to the basic noise filter 604 from the knowledge based module 112.

The SentiMo classifier module 104 receives relevant messages 414 and classifies and categorizes messages into sentiment and dominant emotion categories. The detailed operation of the SentiMo classifier module 104 has been described earlier.

After receiving the categorized messages together with associated sentiments and emotions, the predictive analyzer module 418 performs various trend, influence and predictive analyzes. For example it performs predictive analysis of important outcome variables, such as sales volumes and reputation crisis, such that the results may be used for important business activities of forecasting, monitoring and action strategization.

The predictive analyzer module 418 includes two key components: a predictor and feature set; and a predictive algorithm pool. The outputs of the SentiMo classifier module 104 are provided as object-specific sentiments such as positive, negative, neutral and mixed, and dominant emotions such as anger, sadness and anxiety. These sentiments serve as a new predictor and feature on top of existing predictors and features. The predictive algorithm pool includes publicly available statistical learning tools such as decision trees, random forests, Bayesian networks, support vector machines, neural networks and logistic regression that make use of the feature data of the text messages.

It is useful to note that the predictive analyzer 418 takes into account the other predictors and features, and the selection of a predictive algorithm depends on the outcome variables at stake as well as the application domain. As one example, to predict sales volumes of movie tickets, other variables such as time of release, budget and casting need to be taken into account. In another example, to predict the probability of reputation crisis occurrence, other variables such as direct complaints and news from conventional media need to be taken into account. Advantageously, the precise and sensitive capture of sentiments and emotions from the SentiMo classifier module 104 are expected to enhance the predictive power of existing models.

Further, the predictive analyzer module 418 is capable of providing information on the location where text data is posted, sent or uploaded. In one embodiment, a social media service provider provides a set of APIs with location information, and the predictive analyzer module 418 makes use of the location information to locate the text data and perform predictive analysis. In another embodiment, the predictive analyzer module 418 has built-in functions to identify the location of the text data.

The predictive analyzer module 418 is also capable of providing information on identifying false reviewers of a product or service. In accordance with one embodiment, the predictive analyzer module 418 has built-in functions to identify and track false reviewers based on predictive and behavioral parameters, such as the frequency of users posting reviews on a specific product or service within a specified time frame, and the overall sentiment and emotion of the reviews on this product or service.

The predictive analyzer module 418 is additionally capable of performing trend analysis. In an embodiment, the predictive analyzer module 418 has built-in functions to perform time-series trend analysis on a product or service, consumers, or geographic locations based on text messages (such as reviews and comments) posted on social media.

The results viewer module 420 provides a graphical user interface that displays results interactively and dynamically from the outputs of the predictive analyzer module 418 in response to user inputs. Users can configure a dashboard to view a summary of descriptive results such as sentiment breakdown based on time-series ranges, topics and influencers. In accordance with the present embodiment, results may be displayed, via the results viewer module 420, on any display devices such as mobile devices, monitors or visual systems such as televisions.

The database module 422 is the central data repository for all raw data and analysis results, including intermediate results from the above modules, in order to facilitate dynamic data reading and writing, viewing, visualization and storage needs of various system functions. In the present embodiment, the database module 422 may include databases defined by the knowledge based module 112, the knowledge based adaption module 122, as well as other user defined, purpose-based databases.

FIG. 7 depicts an exemplary computing device 700, hereinafter interchangeably referred to as a computer system 700, where one or more such computing devices 700 may be used to (at least partially) realize the SentiMo sentiment classification method and system discussed hereinabove. The following description of the computing device 700 is provided by way of example only and is not intended to be limiting.

As shown in FIG. 7, the example computing device 700 includes a processor 704 for executing software routines. Although a single processor is shown for the sake of clarity, the computing device 700 may also include a multi-processor system. The processor 704 is connected to a communication infrastructure 706 for communication with other components of the computing device 700. The communication infrastructure 706 may include, for example, a communications bus, cross-bar, or network.

The computing device 700 further includes a main memory 708, such as a random access memory (RAM), and a secondary memory 710. The secondary memory 710 may include, for example, a hard disk drive 712, which may be a hard disk drive, a solid state drive or a hybrid drive and/or a removable storage drive 714, which may include a magnetic tape drive, an optical disk drive, a solid state storage drive (such as a USB flash drive, a flash memory device, a solid state drive or a memory card), or the like. The removable storage drive 714 reads from and/or writes to a removable storage unit 718 in a well-known manner. The removable storage unit 718 may include magnetic tape, optical disk, non-volatile memory storage medium, or the like, which is read by and written to by removable storage drive 714. As will be appreciated by persons skilled in the relevant art(s), the removable storage unit 718 includes a computer readable storage medium having stored therein computer executable program code instructions and/or data.

In an alternative implementation, the secondary memory 710 may additionally or alternatively include other similar means for allowing computer programs or other instructions to be loaded into the computing device 700. Such means can include, for example, a removable storage unit 722 and an interface 720. Examples of a removable storage unit 722 and interface 720 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 722 and interfaces 720 which allow software and data to be transferred from the removable storage unit 722 to the computer system 700.

The computing device 700 also includes at least one communication interface 724. The communication interface 724 allows software and data to be transferred between computing device 700 and external devices via a communication path 726. In various embodiments, the communication interface 724 permits data to be transferred between the computing device 700 and a data communication network, such as a public data or private data communication network. The communication interface 724 may be used to exchange data between different computing devices 700 which such computing devices 700 form part an interconnected computer network. Examples of a communication interface 724 can include a modem, a network interface (such as an Ethernet card), a communication port (such as a serial, parallel, printer, GPIB, IEEE 1394, RJ45, USB), an antenna with associated circuitry and the like. The communication interface 724 may be wired or may be wireless. Software and data transferred via the communication interface 724 are in the form of signals which can be electronic, electromagnetic, optical or other signals capable of being received by communication interface 724. These signals are provided to the communication interface via the communication path 726.

As shown in FIG. 7, the computing device 700 further includes a display interface 702 which performs operations for rendering images to an associated display 730 and an audio interface 732 for performing operations for playing audio content via associated speaker(s) 734.

As used herein, the term “computer program product” may refer, in part, to removable storage unit 718, removable storage unit 722, a hard disk installed in hard disk drive 712, or a carrier wave carrying software over communication path 726 (wireless link or cable) to communication interface 724. Computer readable storage media refers to any non-transitory tangible storage medium that provides recorded instructions and/or data to the computing device 700 for execution and/or processing. Examples of such storage media include magnetic tape, CD-ROM, DVD, Blu-ray™ Disc, a hard disk drive, a ROM or integrated circuit, a solid state drive (such as a USB flash drive, a flash memory device, a solid state drive or a memory card), a hybrid drive, a magneto-optical disk, or a computer readable card such as a PCMCIA card and the like, whether or not such devices are internal or external of the computing device 700. Examples of transitory or non-tangible computer readable transmission media that may also participate in the provision of software, application programs, instructions and/or data to the computing device 700 include radio or infra-red transmission channels as well as a network connection to another computer or networked device, and the Internet or Intranets including e-mail transmissions and information recorded on Websites and the like.

The computer programs (also called computer program code) are stored in main memory 708 and/or secondary memory 710. Computer programs can also be received via the communication interface 724. Such computer programs, when executed, enable the computing device 700 to perform one or more features of embodiments discussed herein. In various embodiments, the computer programs, when executed, enable the processor 704 to perform features of the above-described embodiments. Accordingly, such computer programs represent controllers of the computer system 700.

Software may be stored in a computer program product and loaded into the computing device 700 using the removable storage drive 714, the hard disk drive 712, or the interface 720. Alternatively, the computer program product may be downloaded to the computer system 700 over the communications path 726. The software, when executed by the processor 704, causes the computing device 700 to perform functions of embodiments described herein.

It is to be understood that the embodiment of FIG. 7 is presented merely by way of example. Therefore, in some embodiments one or more features of the computing device 700 may be omitted. Also, in some embodiments, one or more features of the computing device 700 may be combined together. Additionally, in some embodiments, one or more features of the computing device 700 may be split into one or more component parts.

It will be appreciated that the elements illustrated in FIG. 7 function to provide means for performing the various functions and operations of the methods and systems as described in the above embodiments.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1. (canceled)

2. (canceled)

3. A method for producing feature data of a text message, the method comprising:
defining a knowledge based module comprising a plurality of predefined databases including one or more of an emotion dictionary database, a social media lexicon database, a local language lexicon database, a domain lexicon database, and a fuzzy table database;
defining an adaption module in response to user construction of a domain-specific lexicon;
defining middle classes based on the database within the knowledge based module;
receiving a text message and extracting features of the text message, wherein a feature is a finite set of words, phrases or abbreviations expressing predefined purposes;
determining sentence component features of the text message based on grammatical structure between features of each sentence of the text message;
comparing one of the sentence component features with predefined sentence component structures and meanings from the knowledge base module, and applying predetermined sentence rules to the sentence component feature in response to the sentence component feature matching the predetermined sentence component structures and meanings;
calculating a feature value for each feature of the text message in respect to a membership degree of the feature with respect to every predefined middle class;
forming a feature matrix based on the calculated feature values;
calculating sentence component feature values in response to the feature matrix; and
forming a sentence component feature vector in response to the sentence component feature values and sentence component features.

4. The method in accordance with claim 3 further comprising classifying a text message into sentiment valence categories, the classifying step comprising:
computing a degree of similarity of sentences of the text message to predefined middle classes in response to the feature data;
applying a set of fuzzy rules to the feature data corresponding to each sentence of the text message;
assigning each sentence of the text message to a set of middle classes according to predefined middle classes defined by leveraging the plurality of the predefined databases of the knowledge based module;
applying a set of fuzzy sentiment fusion rules to a combination of the middle class of each sentence of the text message and the predefined middle classes to generate a selected category; and
assigning the text message to one or more of a plurality of sentiment valence categories defined by leveraging the knowledge based module, and the dominant features of the text message to one or more of emotions defined by the knowledge based module.

5. The method in accordance with claim 1, wherein the text messages are in English language, non-English languages and a mixture of English and non-English languages.

6. The method in accordance with claim 3, wherein the predetermined sentence rules comprise steps for negating a polarity of a sentiment of a sentence component feature of a text message, the steps comprising:
comparing the sentence component feature with predetermined polarity of sentiment conditions; and
negating the polarity of the sentiment of the sentence component feature in response to the sentence component feature matching the predetermined polarity of sentiment conditions.

7. The method in accordance with claim 3, wherein the predetermined sentence rules further comprises an amplifier handler for increasing the degree of emphasis of a sentence component feature of a text message.

8. The method in accordance with claim 3, wherein the predetermined sentence rules further comprises a diminisher handler for decreasing the degree of emphasis of a sentence component feature of a text message.

9. The method in accordance with claim 3, wherein the predetermined sentence rules further comprise a language usage handler for handling language specific rules for a sentence component feature of a text message configured to:
compare the sentence component feature with a predefined reserved term in the knowledge based module;
apply language specific rules to the sentence component feature to analyze the context and logic of the said sentence component feature;
determine the actual meaning of the sentence component feature; and
assign a polarity of the sentiment of the sentence component.

10. The method in accordance with claim 4, wherein assigning the text message to one or more of the plurality of sentiment valence categories comprising assigning the text message to one or more of the plurality of sentiment valence categories selected from positive categories, negative categories, positive and negative categories, positive, negative and neutral categories, and positive, negative, neutral and mixed categories.

11. The method in accordance with claim 4, further comprising analyzing the text messages to locate where the text messages have been sent from, posted or uploaded.

12. The method in accordance with claim 4, further comprising analyzing the text messages to identify and track false reviewers.

13. Computer readable storage media having stored thereon computer program code for performing, when running on a computing device, the method of claim 1.

14. A system for classifying text messages into sentiment valence categories, the system comprising:
a module for decomposing text messages;
a module for cleaning text messages;
a module for producing feature data of text messages; and
a module for classifying text messages into sentiment valence categories,
wherein the module for producing feature data of the text messages is configured to:
define a knowledge based module comprising a plurality of predefined databases including one or more of an emotion dictionary database, a social media lexicon database, a local language lexicon database, a domain lexicon database, and a fuzzy table database;
define an adaption module in response to user construction of a domain-specific lexicon;
define middle classes based on the database within the knowledge based module;
receive a text message and extract features of the text message, wherein a feature comprises a finite set of words, phrases or abbreviations expressing predefined purposes;
determine sentence component features of the text message based on a grammatical structure between features of each sentence of the text message;
compare one of the sentence component features with predefined sentence component structures and meanings from the knowledge based module, and applying predetermined sentence rules to the sentence component feature in response to the sentence component feature matching the predetermined sentence component structures and meanings;
calculate a feature value for each feature of the text message in respect to a membership degree of the feature with respect to every predefined middle class;
form a feature matrix based on the calculated feature values;
calculate sentence component feature values in response to the feature matrix; and
form a sentence component feature vector in response to the sentence component feature values and sentence component features.

15. (canceled)

16. (canceled)

17. The system in accordance with claim 14 wherein the module for classifying the text message into sentiment valence categories is configured to:
compute a degree of similarity of sentences of the text message to predefined middle classes in response to the feature data;
apply a set of fuzzy rules to the feature data corresponding to each sentence of the text message;
assign each sentence of the text message to a set of middle classes according to the predefined middle classes defined by leveraging the database of the knowledge based module;
apply a set of fuzzy sentiment fusion rules to a combination of the middle class of each sentence of the text message and the predefined middle classes to generate a selected category; and
assign the text message to one or more of a plurality of sentiment valence categories defined by leveraging the knowledge based module, and the dominant features of the text message to one or more of emotions defined by the knowledge based module.

18. The system in accordance with claim 14, wherein the text messages are in English language, non-English languages and a mixture of English and non-English languages.

19. The system in accordance with claim 14, wherein the module for producing feature data of the text messages includes predetermined sentence rules which comprise steps for negating the polarity of sentiment of a sentence component feature of a text message, the steps being configured to:
compare the sentence component feature with predetermined polarity of sentiment conditions; and
negate the polarity of the sentiment of the sentence component feature in response to the sentence component feature matched with the predetermined polarity of sentiment conditions.

20. The system in accordance with claim 19, wherein the predetermined sentence rules further comprise an amplifier handler for increasing the degree of emphasis of a sentence component feature of a text message.

21. The system in accordance with claim 19, wherein the predetermined sentence rules further comprise a diminisher handler for decreasing the degree of emphasis of a sentence component feature of a text message.

22. The system in accordance with claim 19, wherein the predetermined sentence rules further comprise a language usage handler for handling language specific rules for a sentence component feature of a text message, the language usage handler being configured to:
compare the sentence component feature with a predefined reserved term in the knowledge based module;
apply language specific rules to the sentence component feature to analyze the context and logic of the said sentence component feature;
determine the actual meaning of the sentence component feature; and
assign a polarity of the sentiment of the sentence component feature for later processing.

23. The system in accordance with claim 17, wherein the module for classifying the text message into sentiment valence categories further comprises an analysis module configured to locate where text messages have been sent from, posted or uploaded.

24. The system in accordance with claim 17, wherein the module for classifying the text message into sentiment valence categories further comprises an analysis module configured to identify and track false reviewers.
